(19) United States
(12) Patent Application Publication
(10) Pub. No.: US 2017/0262463 A1
(43) Pub. Date: Sep. 14, 2017

(54) METHOD AND SYSTEM FOR MANAGING SHRINKING INODE FILE SPACE CONSUMPTION USING FILE TRIM OPERATIONS

(71) Applicant: Dell Products L.P., Round Rock, TX (US)

(72) Inventors: Itay DAR, Rishon le Zion (IL); Dan BARDOV, Hod Hasharon (IL); Roman YAKOVENKO, Bat Yam (IL)

(21) Appl. No.: 15/068,805

(22) Filed: Mar. 14, 2016

(51) Int. Cl. G06F 17/30; G06F 3/06

(52) U.S. Cl. CPC G06F 17/30138; G06F 3/0608; G06F 3/0644; G06F 3/0652; G06F 3/0647; G06F 3/067; G06F 17/30194

(57) ABSTRACT

A method and a system for dynamically managing a space in a volume of a storage device occupied by an inode file in a file system are provided herein. The method may include: monitoring a file system having an inode file storing a plurality of inodes, wherein the file system manages a storage device, to determine a usage of the space in a volume of the storage device occupied by the inode file; releasing space by applying a trim file operation to a portion of the space occupied by the inode file, wherein said portion of space is not in use by some of the inodes; recording, on the inode file, a data structure pointing to a location of said portion in the inode file; and storing data files or metadata on space in the volume that is associated with the portion of space.

### FIELD OF THE INVENTION

The present invention relates generally to the field of storage, and more particularly to distributed shared files systems implemented on network attached storage (NAS) devices.

### BACKGROUND OF THE INVENTION

FIG. 1 is a block diagram illustrating a non-limiting exemplary architecture of a Network Attached Storage (NAS) device 100, the NAS implementing a distributed shared file system in accordance with the prior art. File system server 30 is reachable via client machine 10 over a network 20. File system server 30 is connected to a bus 40 that employs an Internet Small Computer Systems Interface (iSCSI), a fiber channel (FC) or the like, to a plurality of block storage devices 50. The plurality of block storage devices 50 can be configured as a part of a Storage Area Network (SAN) device aligned, for example, in a Redundant Array of Independent Disks (RAID) configuration.

Upon receiving a request to connect to a specific file from client machine 10, file system server 30 having a plurality of nodes, can undergo a process for determining where the requested file is physically located.

In a UNIX-like distributed shared file system such as file system server 30, the logic file can include two components: content itself and metadata which is the data that describes the content. Examples for metadata may include: access time to the file, permissions relating to changes on the files, mapping tree of the files and the like.

File system 30 may include files that include data or applications that are operable, when executed by processor 32A, to perform functions or provide data. The files may be identified by a unique naming convention (e.g., data.txt, application.exe, and the like). File system 30 may further organize data into structures known as directories. Directories can allow a user or system to group files according to use, functionality and/or other suitable grouping. Directories may also be included within directories as sub-directories to further organize the files. A file system may be further configured to span more than one information handling system. In addition, a file system may be accessible by multiple information handling systems via a network as defined by a Wide Area Network (WAN), Local Area Network (LAN) or Personal Area Network (PAN).

One known implementation in file systems of such a data structure is referred to as an index node (hereinafter: inode) file which is used to store the metadata. Specifically, the files may be identified by an inode. Inodes may include metadata, or a description of attributes, of a file. The inodes may include information about file ownership, access mode (e.g., read and/or write), timestamps, device id., access permissions, file type, and/or pointers. The pointers in the inode may provide information regarding a physical location of the files on storage device 50. A non-limiting example of a file system is a cluster file system which is often found in storage networks. A cluster file system may allow access to any file within the file system regardless of location. A network file storage device (e.g., a device that supports the network file system (NFS) protocol) may require a protocol (e.g., Internet protocol (IP)) to access files within a file system regardless of location. An example of a clustered file system is file system 30 which includes two nodes 38A and 38B.

One of the problems with the aforementioned implementation is that inodes can occupy space even after the file pointed by them is deleted, up till the point they are reused. Presently available architectures thus may lead to space waste, which can be intensified in file systems managing by, for example, tens of thousands of files.

In both static and dynamic inode file systems, there can be a maximal number of inodes that represents the maximum number of files that can be stored on the file systems. Space efficiency can be less of an issue in static inode file systems since, for example, they pre-allocate the inode file during the format process. The space occupied by the inodes can be a problem in dynamic and advanced file systems, which can include a very large number of files, which can further require fairly large inodes for describing many properties of the files and sometimes part of the file data itself.

### SUMMARY OF THE INVENTION

Embodiments of the present invention introduce the concept of a shrinking inode file space using file trim operations. Using that concept, the consumption of the inode file space becomes much more efficient. The method may include: monitoring a file system having at least one inode wherein the files system is attached to a storage device, to determine a usage of space on the file system by the inode; releasing space in the file system by applying a trim file operation to the file space occupied by at least one inode not in use at the inode file; recording, on the inode file, a data structure pointing to the trimmed inode location previously occupied by the at least one inode not in use; and storing data files or metadata on the released space. The system according to embodiments of the present invention can implement the aforementioned method over a distributed file server.

In accordance with some embodiments of the present invention, releasing of the file space may be carried out only whenever a predefined threshold associated with the usage of space by the inode file is crossed.

In accordance with some embodiments of the present invention wherein the predefined threshold is a ratio between space occupied by the inodes not in use on the inode file and a total space occupied by the data files and the metadata on the file system.

In accordance with some embodiments of the present invention, the method may further include a step of reusing the released space as space for inodes, whenever more inodes need to be used.

In accordance with some embodiments of the present invention, each of the inode files may be split into pages where each page has the same size, and wherein each of the pages is one of a plurality types comprising: an allocated inode, a free page, a free list page, and a header page.

In accordance with some embodiments of the present invention, the header page may hold a plurality of properties comprising: number of free pages in the free-inode free list, a number of free pages in the punched-inode free list, a pointer to the next free list page in the mode-free list, and a pointer to the next free list page in the punched-inode free list.

In accordance with some embodiments of the present invention, the free-list page may hold a plurality of properties comprising: a pointer to the next free list page denotes next-page, a generation number of the free list page, and an array of free pages IDs and their respectable generation.

In accordance with some embodiments of the present invention, the specified criterion may be an overhead ratio between amounts of space consumed by pages in the free-inode free list to the total space used in the file system.

In accordance with some embodiments of the present invention, in a case that the aforementioned ratio is above a certain threshold the page is being punched and added to the punched-inode free list and the counters of punched-inode in the header is being incremented, otherwise the page is being added to the free-inode free list and the counters of pages in the free-inode list are being updated.

In accordance with some embodiments of the present invention, the operation of adding a page to free list may include the following steps: in a case that that there is enough room at the current page at the head of the list than the page ID is added to it with the incremented generation, wherein in a case that there is not enough space the page is being written as free-list page which points to the free-list head page as the next page and the header pointer to the free-list is being updated to point to this page.

In accordance with some embodiments of the present invention, if the aforementioned ratio is above a certain threshold the system starts moving pages from the inode-free list to the punched-inode list till a lower overhead ratio threshold is reached.

In accordance with some embodiments of the present invention, the process of moving pages may be carried out as follows: the head page of the mode-free list is being read into memory (page P); the header of the inode-file is being updated such the mode-free pointer is updated with the next free-list page of the mode-free list (the next-page of page P); each of the pages listed by page P is punched; and page P is inserted into the punched-inode-free list.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a system in accordance with embodiments of the prior art;

FIG. 2 is a block diagram illustrating non-limiting exemplary architecture of a system in accordance with embodiments of the present invention; and

FIG. 3 is a high level flowchart illustrating a non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

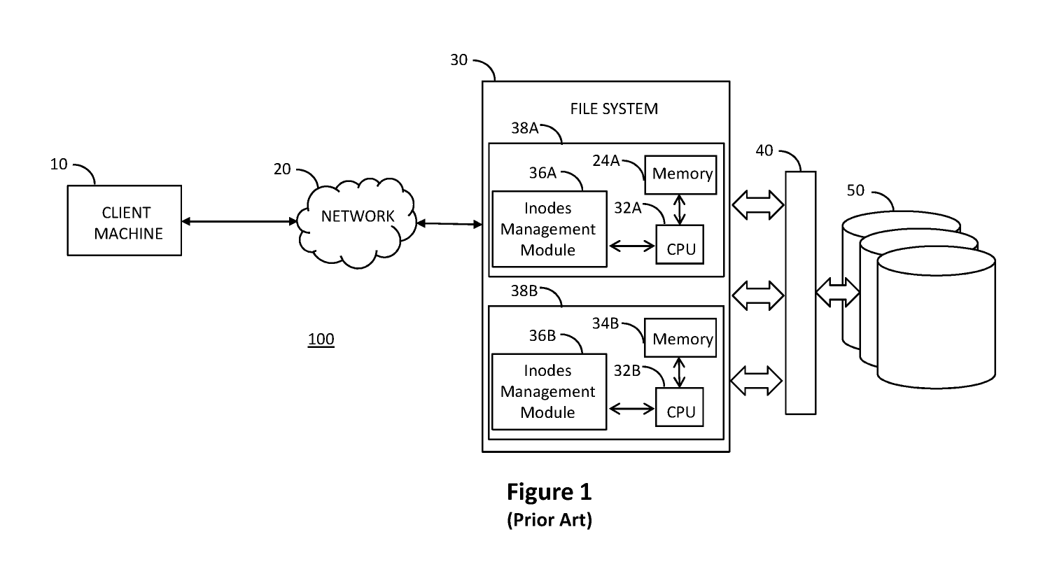

FIG. 1 is a block diagram illustrating the aforementioned non-limiting exemplary architecture of a system in accordance with embodiments of the prior art. In addition to the standard file system architecture discussed above, the file systems may include inode management modules 36A and 36B which are executed over processors 32A and 32B and memory modules 34A and 34B respectively. Inodes for a specific file may include information regarding file ownership, access mode (e.g., read and/or write), execute permissions, and/or file type. The inode may also include pointers that may be used to determine the physical address of a file's data.

The inode location inside the file provides its inode number. It is evident that a fast and efficient access to the inodes (and generally, the file metadata) contribute to the performance of the file system. The inode number attribute can be used in various applications to identify the file for various needs, for example, detecting hard links and integration with incremental backup.

Embodiments of the present invention as described in detail hereinafter provide a dynamic approach to managing how the space on the file system by the inode

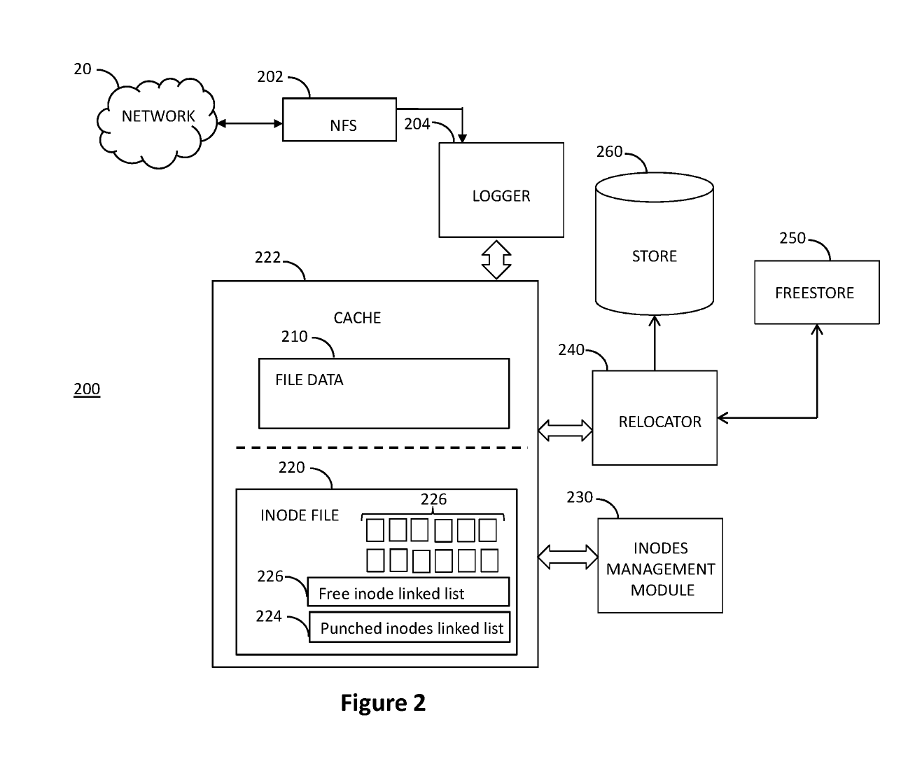

FIG. 2 is a block diagram illustrating non-limiting possible logic implementation of a system in accordance with embodiments of the present invention. A part of a NAS file system 200 is shown here (client machines and communication network omitted for simplification) with a file network file system (NFS) server connected to a network 20 which is connected in turn to a plurality of client machines (not shown here). NFS server 202 is connected to a logger 204 which is a process that manages cache memory 222 which serves as an intermediate platform on which files and identifiers are stored before being uploaded to store 260 by a process known as relocator 240. In Operation, after relocator 240 is requested to upload files on store 260, relocator 240 consults with freestore process 250 which provides information regarding how much free space is available on store 260. It is assumed that any

It is understood that all of the aforementioned processes and modules run over one or more computer processors (not shown here) that are implemented on the one or more nodes (not shown here) of file system 200. It is assumed, for a better understanding of embodiments of the present invention, that any logical action carried out on cache 222 which relates to files on file system 200 is eventually onto store 260 and thereafter to the physical storage devices (not shown here) of file system 200.

In accordance with embodiments of the present invention, the aforementioned architecture of file system 200 is augmented by an inode monitoring module 230 that is configured to manage a dynamically sized inode file 220 on cache 222. Specifically, inode management module 230 is configured to cause file system 200 to release the space in the volume of storage devices (not shown here) being occupied by unused inodes (some of inode 226). As explained above, any release of inodes on cache 222 will be implemented by relocator 240 at store 260 and physical storage devices (not shown here).

In accordance with embodiments of the present invention, the release of the space of unused inodes (some of inodes 226) can be achieved, for example, using a punch hole file operation on the inode file releasing space. The release of space is required because the inode ID space is still limited and in order to avoid expanding the file size of the inode file indefinitely. Since these inodes locations may be reused in the future for new data, it is necessary to manage somehow the pool of punched inodes so once needed, they can be reused. It is therefore suggested to keep a linked list of the punched inodes 224 on cache 222 as well as a linked list of the free inodes 222.

Whereas reusability of the inodes while preserving space is an important aspect of a file system by its own merit, there are further benefits of not releasing the inodes. Such advantages may include the efficiency of coalescing updates to media, replication, state enumeration and other related tasks.

In accordance with some embodiments of the present invention, each of the inode files is split into pages where each page has the same size (typically 4K). Each of the pages can be one of a few types as follows: an allocated inode (e.g., valid file pointed to by the file system), a free page, a free list page, and a header page.

In accordance with some embodiments of the present invention, the header page may hold the following properties: number of free pages in the free-inode free list, a number of free pages in the punched-inode free list, a pointer to the next free list page in the inode-free list (the ID of the page), and a pointer to the next free list page in the punched-inode free list (the ID of the page).

In accordance with some embodiments of the present invention, the free-list page may hold the following properties: a pointer to the next free list page denotes next-page, a generation number of the free list page, and an array of free pages IDs and their respectable generation.

In accordance with some embodiments of the present invention, when a file is being deleted in the system, its inode is eventually being reclaimed and being freed to the inode file subsystem which provides the inode number and carries out its respective generation.

In accordance with embodiments of the present invention, inodes management module 230 is looking at the overhead ratio between amounts of space consumed by pages in the free-inode free list 226 (including the link pages) to the total space used in the file system (a parameter than can be obtained, for example, from freestore module 250). In a case that this ratio is above a certain threshold the page is being punched and added to the punched-inode free list 224 and the counters of punched-inode in the header is being incremented, otherwise the page is being added to the free-inode free list 226 and the counters of pages in the free-inode list are being updated.

In accordance with some embodiments of the present invention, the operation of adding a page to free inode list 226 may include the following steps: in a case that that there is enough room at the current page at the head of the list than the page ID is added to it with the incremented generation. In a case that there is not enough space the page is being written as free-list page which points to the free-list head page as the next page and the header pointer to the free-list is being updated to point to this page.

Periodically, inodes management module 230 may be scheduled to look at the overhead ratio. If the ratio is above a certain threshold the system starts moving pages from the inode-free list to the punched-inode list till a lower overhead ratio threshold is reached.

In accordance with some embodiments of the present invention, the process of moving pages may be carried out by inodes management module 230 as follows: the head page of the mode-free list is being read into memory (known as page P); the header of the mode-file is being updated such the inode-free pointer is updated with the next free-list page of the inode-free list 226 (the next-page of page P); each of the pages listed by page P is punched; and page P is inserted into the punched-inode-free list 224.

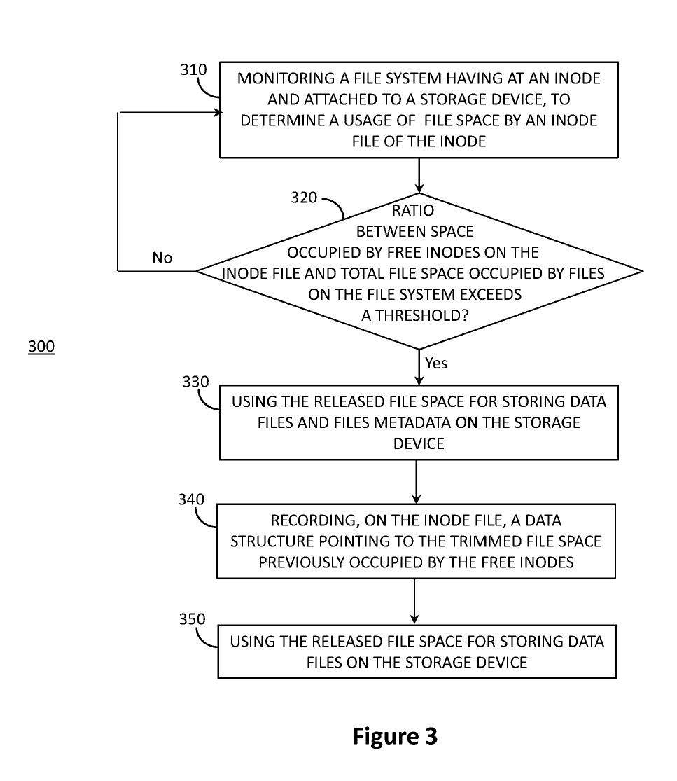

FIG. 3 is a high level flowchart illustrating a non-limiting exemplary method of generating out-of-band notifications of client activity in a NAS device in accordance with embodiments of the present invention. Method 300 may be implemented by any NAS device and is not necessarily limited to the aforementioned architectures of NAS file system 200.

Method 300 may include the following steps monitoring a file system having at an inode and attached to a storage device, to determine a usage of file space by an inode file of the inode 310; checking an inode file usage metric which may be a ratio between space occupied by free inodes on the inode file and total file space occupied by files on the file system 320. In case the ratio exceeds a predefined threshold, releasing file space on the file system by applying a trim file operation to the file space occupied by free inodes on the inode file 330; recording, on the inode file, a data structure pointing to the trimmed file space previously occupied by the free inodes 340; and using the released file space for storing data files on storage device 350.

It should be noted that method 300 according to embodiments of the present invention may be stored as instructions in a computer readable medium to cause processors, such as central processing units (CPU) 32A to 32B, on nodes 38A to 38B to perform the method. Additionally, the method described in the present disclosure can be stored as instructions in a non-transitory computer readable medium, such as storage devices 50 which may include hard disk drives, solid state drives, flash memories, and the like.

In order to implement the method according to embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized in order to implement the aforementioned method. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of dynamically managing a space in a volume of a storage device occupied by an inode file in a file system, the method comprising:
monitoring a file system having at least one inode file storing a plurality of inodes, wherein the file system manages a storage device, to determine a usage of the space in a volume of the storage device occupied by the inode file;
releasing space in the said file system by applying a trim file operation to a portion of the space occupied by the at least one inode file, wherein said portion of space is not in use by some of the inodes;
recording, on said inode file, a data structure pointing to a location of said portion in the inode file; and
storing data files or metadata on space in said volume that is associated with said portion of space.

2. The method according to claim 1, wherein the releasing of the file space is carried out only whenever a predefined threshold associated with the usage of space by the inode file is crossed.

3. The method according to claim 2, wherein the predefined threshold is based on a ratio between space occupied by the inodes not in use on the inode file and a total space occupied by the data files and the metadata on the file system.

4. The method according to claim 1, further comprising reusing the released space as space for inodes, whenever more inodes need to be used.

5. The method according to claim 1, wherein the inode file is split into pages where each page has a same size, and wherein each of the pages is one of a plurality types comprising: an allocated inode, a free page, a free list page, and a header page.

6. The method according to claim 5, wherein the data structure comprises a punch-inode list pointing to the portion where the trim operation was applied.

7. A system for dynamically managing a space in a volume of a storage device occupied by an inode file in a file system, the system comprising:
a file system having least one inode file storing a plurality of inodes, wherein the file system is being executed by one or more computer processors and manages a storage device; and
an inode management module executed by at least one computer processors anf configured to:
monitor said file system, to determine a usage of the space in a volume of the storage device occupied by the inode file;
release space in the said file system by applying a trim file operation to a portion of the space occupied by the at least one inode file, wherein said portion of space is not in use by some of the inodes;
record, on said inode file, a data structure pointing to a location of said portion in the inode file; and
store data files or metadata on space in said volume that is associated with said portion of space.

8. The system according to claim 6, wherein the releasing of the file space is carried out only whenever a predefined threshold associated with the usage of space by the inode file is crossed.

9. The system according to claim 7, wherein the predefined threshold is based on a ratio between space occupied by the inodes not in use on the inode file and a total space occupied by the data files and the metadata on the file system.

10. The system according to claim 6, further comprising reusing the released space as space for inodes, whenever more inodes need to be used.

11. The system according to claim 6, wherein the inode file is split into pages where each page has a same size, and wherein each of the pages is one of a plurality types comprising: an allocated inode, a free page, a free list page, and a header page.

12. The system according to claim 1, wherein the data structure comprises a punch-inode list pointing to the portion where the trim operation was applied.

13. A non-transitory computer readable medium comprising a set of instructions that when executed cause at least one processor to:
monitor a file system having at least one inode file storing a plurality of inodes, wherein the file system manages a storage device, to determine a usage of the space in a volume of the storage device occupied by the inode file;
release space in the said file system by applying a trim file operation to a portion of the space occupied by the at least one inode file, wherein said portion of space is not in use by some of the inodes;
record, on said inode file, a data structure pointing to a location of said portion in the inode file; and
store data files or metadata on space in said volume that is associated with said portion of space.

14. The non-transitory computer readable medium according to claim 13, wherein the releasing of the file space is carried out only whenever a predefined threshold associated with the usage of space by the inode file is crossed.

15. The non-transitory computer readable medium according to claim 14, wherein the predefined threshold is based on a ratio between space occupied by the inodes not in use on the inode file and a total space occupied by the data files and the metadata on the file system.

16. The non-transitory computer readable medium according to claim 13, further comprising a set of instructions that when executed cause said least one processor to reuse the released space as space for inodes, whenever more inodes need to be used.

17. The non-transitory computer readable medium according to claim 13, wherein the inode file is split into pages where each page has a same size, and wherein each of the pages is one of a plurality types comprising: an allocated inode, a free page, a free list page, and a header page.

18. The non-transitory computer readable medium according to claim 17, wherein the data structure comprises a punch-inode list pointing to the portion where the trim operation was applied.
